(19) United States
(12) Patent Application Publication
(10) Pub. No.: US 2003/0053236 A1
(43) Pub. Date: Mar. 20, 2003

(54) System for combining automatic gain control values in a disc drive to perform drive performance operations

(76) Inventors: David Kok Leong Loh, Singapore (SG); Victor Chew Weng Khin, Singapore (SG); Quek Leong Choo, Singapore (SG); Myint Ngwe, Singapore (SG); KahLiang Gan, Singapore (SG)

Correspondence Address: Joseph R. Kelly, WESTMAN CHAMPLIN & KELLY, International Centre, Suite 1600, 900 South Second Avenue, Minneapolis, MN, 55402-3319, US

(21) Appl. No.: 10/153,103

(22) Filed: May 22, 2002

Related U.S. Application Data
(60) Provisional application No. 60/323,776, filed on Sep. 20, 2001.

(51) Int. Cl. G11B 27/36; G11B 5/02

(52) U.S. Cl. 360/31; 360/67

(57) ABSTRACT

A representation of the signal level on a data head is obtained by combining the signal level values corresponding to more than one sector of a track on a disc surface. This makes it much easier to lock on to a relatively accurate representation of the actual head signal amplitude, even in the presence of servo disturbances.

### CROSS-REFERENCE TO RELATED APPLICATION

This application claims priority from U.S. Provisional Application No. 60/323,776 filed on Sep. 20, 2001 for inventors David Kok Leong Loh, Victor Weng Khin, Quek Leong Choo, Myint Ngwe and KahLiang Gan and entitled IMPLEMENTATION OF AVERAGE AUTOMATIC GAIN CONTROL (AGC) IN CHANNEL CHIP.

### FIELD OF THE INVENTION

The present invention relates generally to disc drives, and more particularly but not by limitation to averaging automatic gain control values in the disc drive to obtain a more accurate indication of signal amplitude.

### BACKGROUND OF THE INVENTION

In conventional disc drives, a plurality of discs, with recording surfaces, are typically mounted for rotation about a spindle. A transducer is supported proximate to the rotatable discs to access data on the disc surfaces. In order to write data on the disc surface a write signal is provided by a disc drive controller, through conditioning circuitry, to the transducer, and the transducer encodes information representative of the data to be written, on the disc surface. During a read operation, the disc surfaces move relative to the transducer, and the transducer generates a read signal which is indicative of the data encoded on the disc surface. The signal is provided, again through conditioning circuitry, such that it can be used by a remainder of the circuit. The circuitry used during the write operation is conventionally referred to as the write channel, while the circuitry used during the read operation is conventionally referred to as the read channel. The read and write channels can be implemented in a semiconductor device referred to as the read/write channel chip.

The conditioning circuitry used in the read and write channels typically includes a preamplifier and an automatic gain control circuit or a variable gain amplifier. The preamplifier is used to amplify the signals to appropriate levels, while the automatic gain control circuit (or variable gain amplifier) is used to maintain a desired signal level.

The disc surfaces in the disc drive typically include a plurality of concentrically arranged data tracks for storing information. Each data track is conventionally divided into a plurality of sectors, each of which includes a plurality of different fields. The fields include a data field where data is written to the sector, and from which data is read from the sector.

In order to access the disc surfaces (i.e., in order to read information from the disc surfaces or write information to the disc surfaces) a servo system is used. The servo system moves the transducer (sometimes referred to as the data head) radially relative to the disc surfaces to position the transducer at a desired concentric track location. As the disc rotates, the transducer can thus access each of the sectors on the track.

The signal amplitude obtainable from the head directly affects its signal-to-noise ratio. Because of this, careful monitoring of signal amplitude is often useful in drive tuning and head screening. Such drive tuning and head screen typically includes, for example, developing a microtrack profile, characterizing reader/writer offset, setting up default values for the variable gain amplifier in different zones on the disc surface, etc.

Monitoring the signal amplitude has, in the past, been done using digital-to-analog converter (DAC) register values from the automatic gain control (AGC) circuit or variable gain amplifier (VGA) circuit. This gives a value which is indicative of the actual head signal level.

The AGC or VGA is typically located at the first function block of the read/write channel chip. Thus, the information collected from these sources has a fairly close representation of the signal amplitude, just after the preamplifier.

However, in a disc drive implementation, the AGC adapts to a new level upon every read gate. That is, when reading data from a track, there is a read gate signal generated for each sector on a track, and the AGC is configured to adapt its output level upon receiving the read gate signal. In recent disc drive technology, however, servo disturbances such as repeatable run out (RRO) and non-repeatable run out (NRRO) have become a relatively common occurrence. When these servo disturbances occur, the gain of the amplifier correspondingly fluctuates along the track. Thus, AGC (or VGA) values collected from one sector are often vastly different from those collected on another sector of the same track. This makes it very difficult to lock onto a correct AGC value and also makes it difficult to represent the actual head signal amplitude. This drastically affects the performance of any drive performance operations (such as testing or tuning) that utilize AGC or VGA values. Again, such operations can include microtrack profiling, reader/writer offset tuning, and the setup of default VGA or AGC values per zone, among others.

Embodiments of the present invention provide solutions to, or addresses, one or more of these or other problems, and offer other advantages over the prior art.

### SUMMARY OF THE INVENTION

In the present invention, a representation of a signal level on a data head is obtained by combining the signal level values corresponding to more than one sector. This makes it much easier to lock on to a relatively accurate representation of the actual track signal amplitude, even in the presence of servo disturbances.

In one embodiment, the representation of the signal amplitude is averaged over the entire track. In another embodiment, the combination of the signal amplitude values is done in hardware to reduce processing time and the number of firmware calculations required.

In yet another embodiment, a deviation is obtained for the amplitude values corresponding to each sector, such that aberrant or erroneous sectors can be identified and treated with desired remedial action.

The present invention can be implemented both as a circuit configured to calculate the amplitude value, and as a method for obtaining a reliable representation of signal strength. The invention thus mitigates the effects of servo disturbances and can be configured to detect media defects.

Other features and benefits that characterize embodiments of the present invention will be apparent upon reading the following detailed description and review of the associated drawings.

### BRIEF DESCRIPTION OF THE DRAWINGS

FIG. 1 is an isometric view of a disc drive in accordance with one embodiment of the present invention.

FIGS. 2 and 3 are graphs of AGC value versus sector number for a disc drive with excessive repeatable run out and for a disc drive without excessive repeatable run out, respectively.

FIG. 4 is a block diagram illustrating a system for averaging AGC values in accordance with one embodiment of the present invention.

FIG. 5 illustrates register values in accordance with one embodiment of the present invention.

FIG. 6 is a flow diagram further illustrating operation of but one embodiment of the present invention.

### DETAILED DESCRIPTION OF ILLUSTRATIVE EMBODIMENTS

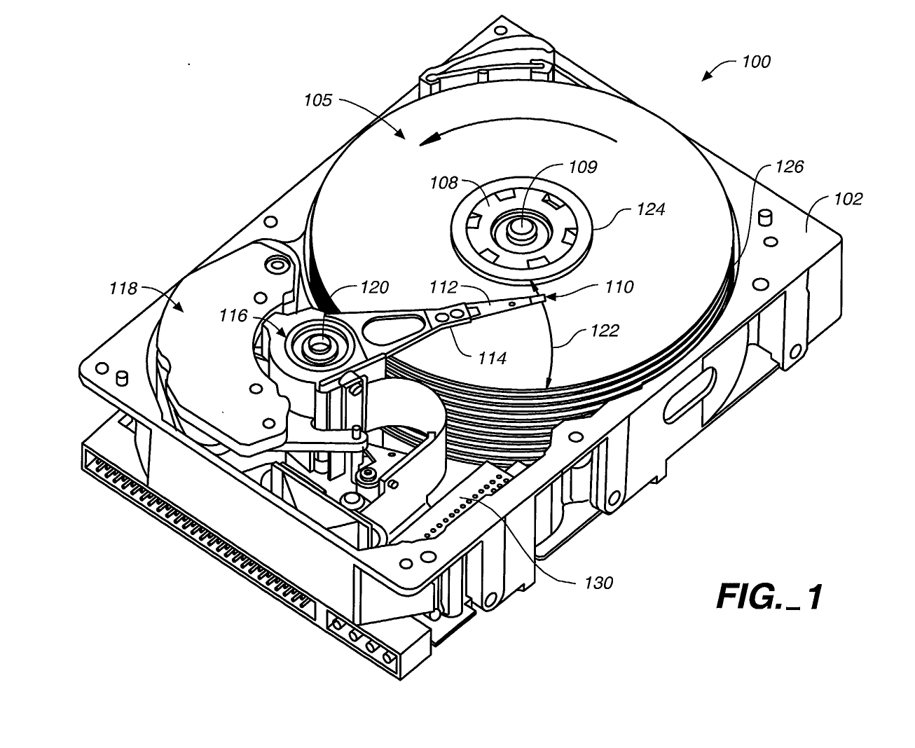

FIG. 1 is an isometric view of a disc drive 100 in which embodiments of the present invention are useful. Disc drive 100 includes a housing with a base 102 and a top cover (not shown). Disc drive 100 further includes a disc pack 106, that is mounted on a spindle motor (not shown) by a disc clamp 108. Disc pack 106 includes a plurality of individual discs, that are mounted for co-rotation about central axis 109. Each disc surface has an associated disc head slider 100 that is mounted to disc drive 100 for communication with the disc surface. In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by servo electronics 130 based on signals generated by heads 110 and a host computer (not shown).

As is discussed in the background portion of the specification, the signal level obtainable from the head (or transducer) 110 directly affects its signal-to-noise ratio. Because of this, careful monitoring of the signal amplitude is often useful in drive tuning and head screening. Also, for reasons stated in the background portion of the specification, the AGC values associated with each head can vary widely due to servo disturbances, such as repeatable run out.

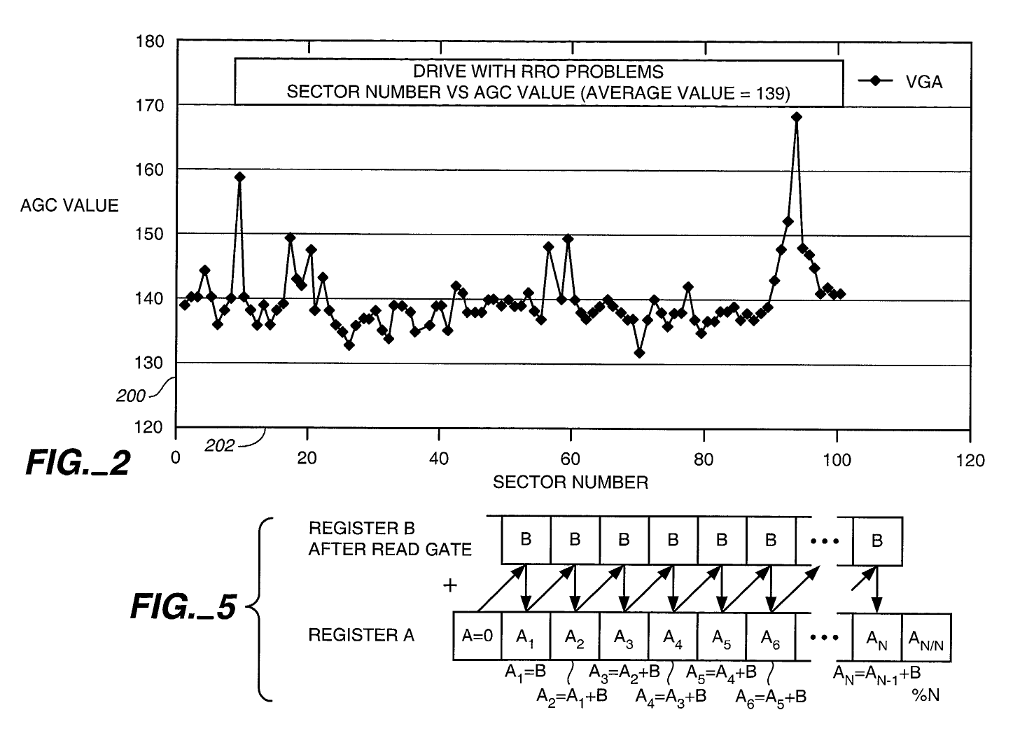

For example, FIG. 2 shows a graph of AGC value 200 versus sector number 202 for a disc drive which has excessive repeatable run out. It can be seen that the AGC value varies widely from sector-to-sector.

However, FIG. 3 illustrates the same plot (AGC value 200 versus sector number 202) for a disc drive without such excessive repeatable run out. These Figures illustrate that the readings of the AGC (or VGA) value are dramatically different from sector-to-sector, where sectors experience servo disturbances. Thus, if representation of the signal strength is based on such sectors, errors will likely occur. This is exacerbated by past systems which tended to monitor the AGC (or VGA) value on a sector-by-sector basis. Henceforth, for purposes of this description, the term AGC will be deemed to include VGA, and vice versa such that an AGC component may be a VGA component, instead.

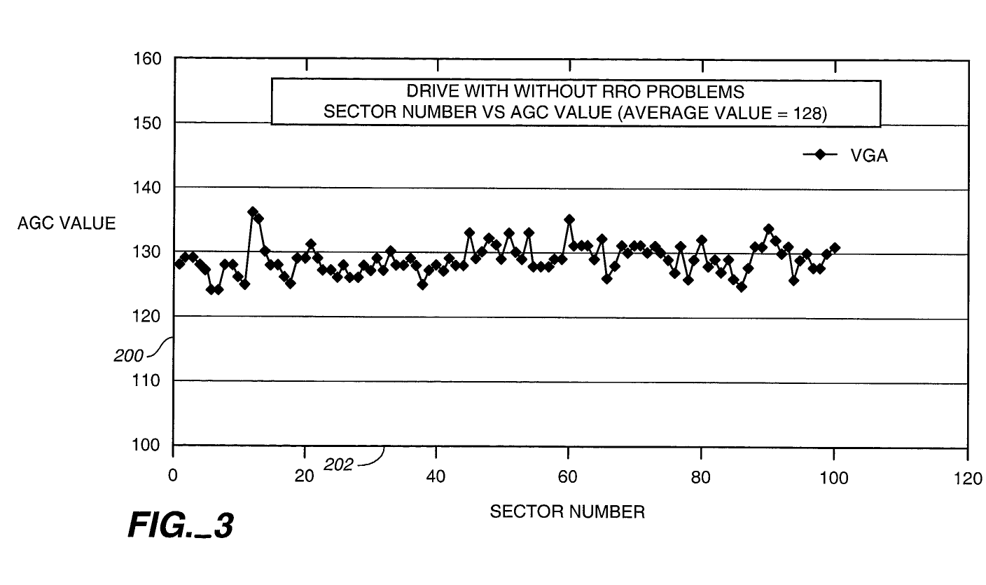

FIG. 4 is a block diagram illustrating a system 300 which addresses this problem. System 300 includes automatic gain control (AGC) or variable gain amplifier (VGA) circuit 302, read/write preamplifiers 304, head 110 and a disc surface 111 of one of the discs in disc pack 106. System 300 also includes counter 306, register B (designated by numeral 308), summing node 310, register A (designated by numeral 312), averaging circuit 314, optional deviation generator 316 and optional comparator 318. In accordance with normal operation of disc drive 100, in order to write data to disc surface 111, a write signal is provided to AGC block 302 where its level is brought into conformance with desired signal levels. The signal is provided to read/write preamplifiers 304 and on to head 110 which writes the information to disc surface 111. In order to read data from disc surface 111 the disc is rotated relative to head 110 which generates a read signal indicative of the data encoded on the surface 111 of the disc. That signal is provided to read/write preamplifiers 304 which amplify the signal to a level that can be used by the remainder of the circuit. The amplified signal is provided to AGC circuit 302 and back to the controller, or the remaining circuitry which receives the amplified read signal.

As discussed above, the present invention monitors the AGC value in AGC circuit 302 to obtain an indication of the signal amplitude recorded on disc surface 111 and generated by head 110. In order to accommodate servo disturbances, but still obtain a relatively accurate representation of the signal amplitude, the present invention averages the AGC value over a number of sectors in order to average out aberrant sectors having values induced by servo disturbances.

In the embodiment first described, the average is taken over an entire track. Thus, in the embodiment shown in FIG. 4, register B 308 is configured to receive the AGC value from AGC 302 upon each read gate signal. Of course, there is one read gate signal per sector. Register A 312 is configured to hold the sum of all AGC values, for all sectors in the track. Thus, during operation, when the first sector is read, the AGC value from the first sector is loaded into register B 308. That register value is summed with the current value in register A 312, by summing node 310. Since the initial value in register A 312 is zero, the value loaded into register A 312 is the initial AGC value. When head 110 encounters the next sector and the next read gate signal is received, the AGC value for that sector is loaded into register B 308 and is added to the current value in register A 312 by summing node 310. The sum is then placed in register A 312. Thus, it can be seen that register B 308 holds the specific AGC value corresponding to the given sector then being read. Register A 312 holds the sum of all AGC values for the track thus far.

The read gate signal is also provided to counter 306. After the entire track has been read, the track change signal causes counter 306 to be reset, and also causes the value in counter 306 to be loaded into averager 314. Thus, the value loaded into averager 314 is the count of the number of read gates (e.g., the number of sectors) for which AGC values have been summed and loaded into register A 312. Averager 314 simply divides the final value for the track in register A 312 by the number of sectors read to obtain the average. This is indicated by equation 1.

$$A ( N ) = \frac{1}{N} {\sum }_{n = 0}^{N - 1} B ( n ) \qquad Eq . 1$$

Where is sample number;

N is the total number of sectors read;

A(N) is the final value in register A which represents the average AGC value for the track; and

B(n) represents the AGC value for the nth sector.

The final average value stored in register A 312 can then be used in performing such drive performance operations as drive tuning and head screening. For example, that value can be used in the micro track profiling procedure, the read/write offset tuning procedure, setting up defaults for the VGA(or AGC) per concentric zone on the track, etc.

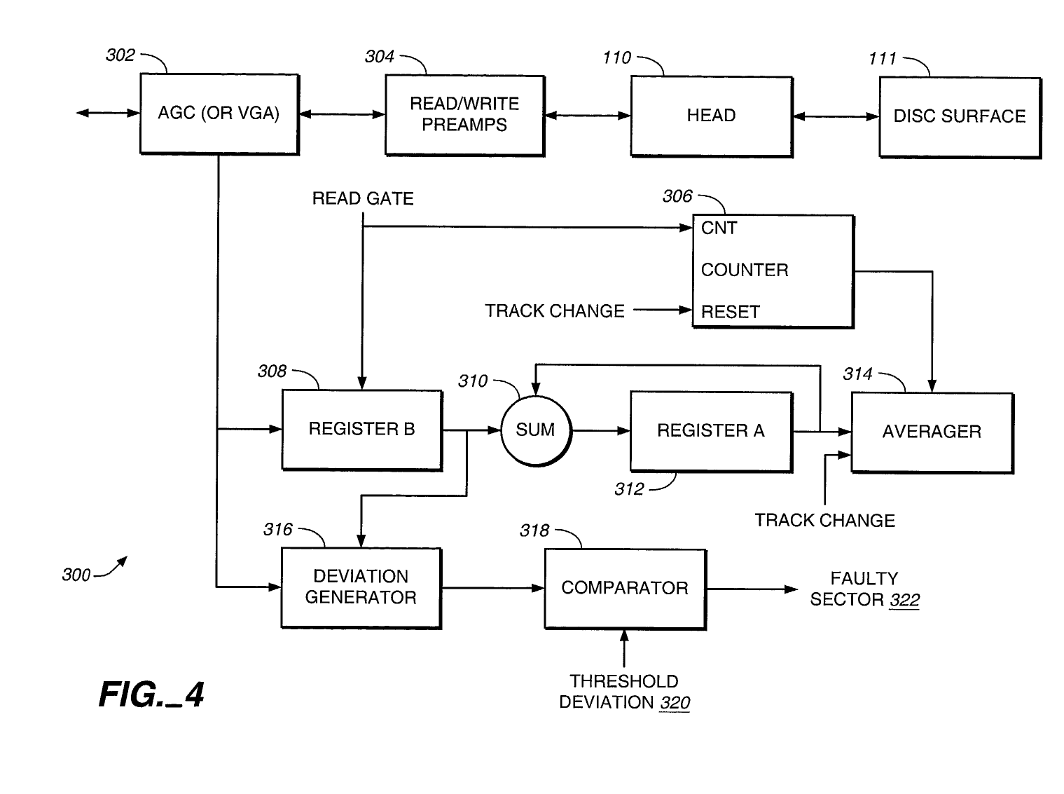

The averaging is also illustrated by FIG. 5. FIG. 5 shows a plurality of different values stored in register A 312 and a plurality of different values stored in register B 308. Initially, the value stored in register A is zero. However, after one read gate (e.g., after an AGC value for a sector is read), the value in register B is the AGC value associated with that sector and the value in register A is A1=B.

After another read gate (i.e., after two sectors have been read) the value in register B is the AGC value for the second sector, but the value in register A is A2=A1+B, which is the sum of values in the first and second registers. When a third sector is read, the value in register B will again be the AGC value for that sector, while the value in register A will be A3=A2+B which is the previous sum in register A plus the AGC value for sector 3. This continues until all N sectors of a track have been read. Then, averager 314 averages the values by taking the total sum of the AGC values in register A and dividing it by the number of sectors read and replacing the average value in register A. Of course, the averager 314 could place that value in any other storage location as well.

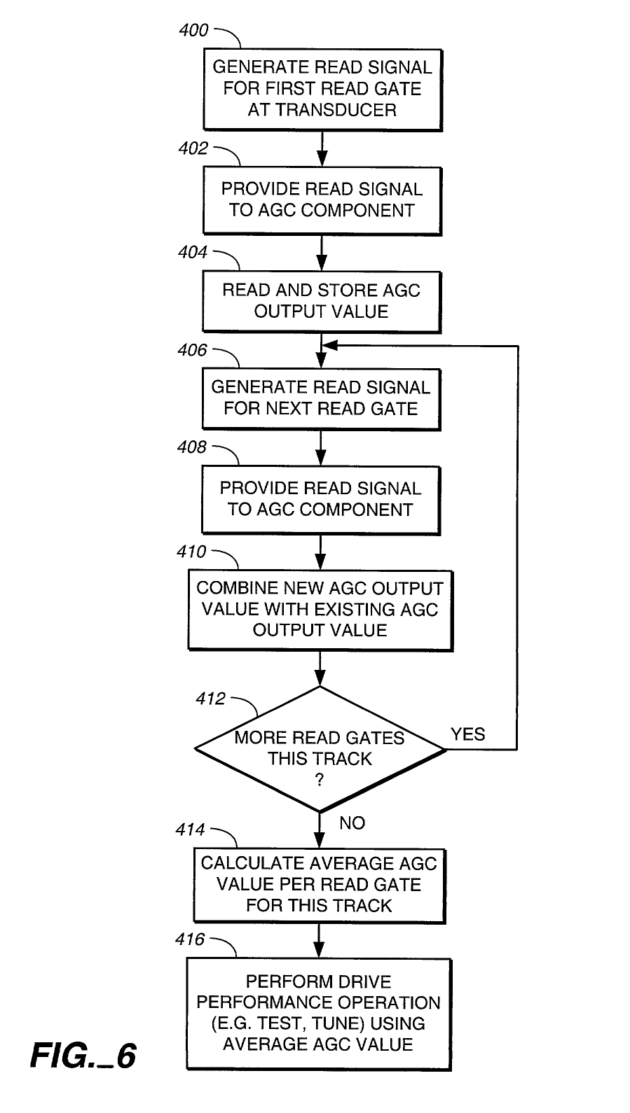

FIG. 6 is a flow diagram which further illustrates operation of but one embodiment of the present invention. First, the read signal for the first read gate is generated from disc surface 111 by head (transducer) 110. The read signal is provided to AGC component 302 through preamps 304. These steps are indicated by blocks 400 and 402 in FIG. 6. The output from AGC component 302 is then read and stored in register B 308. This is indicated by block 404. The value from register B 308 is then summed with the value in register A 312 (which is currently 0) and the sum from summing block 310 is placed in register A 312.

The read signal for the next read gate is generated from disc surface 111 by transducer 110 and is provided to AGC component 302 through preamps 304. These steps are indicated by blocks 406 and 408 in FIG. 6.

The new value from AGC component 302 is then read and stored into register B 308, and is added to the current value in register A 312 by summing block 310. That sum is then placed back in register A 312. This is indicated by block 410 in FIG. 6.

It is then determined whether there are any additional read gates for this track (i.e., whether more sectors need to be read for the current track). This is indicated by block 412. If so, processing continues at block 306 where the read signal is provided to AGC component 302, the value in AGC component 302 is read out and combined with the current value in register A 312. Once all of the sectors on the current track have been read, processing proceeds to block 414 in FIG. 6. Block 414 indicates that averager 314 calculates the average AGC value per read gate for this track. As discussed above, this is done by basically dividing the current sum in register A 312 (which represents the sum of all AGC values for the sectors in this track) by the total number of read gates contained in counter 306 (which presents the total number of sectors read).

Once the average value is calculated and block 314, the disc drive performance operations (such as drive tuning and testing) are performed utilizing the average AGC value determined. This is indicated by block 416. Of course, as indicated previously in the specification, these performance operations can include such things as microtrack profiling, reader/writer offset tuning, setting up default AGC values in each zone, etc.

Referring again to FIG. 4 an additional use of system 300 is illustrated. For example, the system can determine a deviation in the AGC value from adjacent sectors and thus determine whether the AGC value corresponds to an aberrant sector which has excess servo disturbances. In that embodiment, the AGC value from AGC block 302 is provided to deviation generator 316. Deviation generator 316 also receives an input from the value currently contained in register B 308. The deviation generator determines a deviation of the AGC value of the sector just read from the AGC value of the sector just previously read by implementing the mathematical expression shown in equation 2:

$$D ( N ) = \frac{1}{N} {\sum }_{n = 0}^{N - 1} {[ B ( n ) - B ( n - 1 ) ]}^{2} \qquad Eq . 2$$

where n is the sample number;

N is the total number of sectors read;

B (n) represents the AGC value for the nth sector; and

D is the deviation.

The deviation value calculated in block 316 is provided to comparator 318 which compares the instantaneous deviation value to a threshold deviation value 320. If the deviation value from generator 316 is larger than the predefined threshold value 320, this indicates a faulty sector (either because of excessive repeatable run out or a media defect) and an appropriate faulty sector output 322 is provided. This allows other remedial action to be taken such as mapping out that sector or removing its value from the average.

It should also be noted that the present invention can be implemented without averaging an entire track. In that embodiment, register A can be configured to divide by two the sum therein such that a running average can be obtained for the track. In that instance the deviation generator 316 can measure the difference between the running average and the current sample to show a faulty sector. Further, the present invention can be utilized if only some of the sectors are averaged, rather than every single sector.

Similarly, the present invention can be applied to other channel and preamplifier blocks, such as the phase locked loop (for frequency and phase monitoring) and for signal quality monitoring in the drive. The values derived therefrom are useful when monitoring or mitigating head signal modulation, average signal quality, etc. It should also be noted that the present invention can be implemented in either firmware or hardware. If the invention is implemented in hardware, this improves test time and reduces the dependence on firmware to make such calculations.

Thus, the present invention provides a more reliable representation of signal strength coming from the disc. This is done by averaging the AGC (or VGA) value. This mitigates the affects of servo disturbances on later analysis. It also allows the repeatable run out optional detection sectors affected by, or media defective sectors, so that remedial action can be invoked.

The present invention can include a method of determining a signal level of a read signal in a disc drive 100 generated by a transducer 110 from data written on a track of disc 106. The method includes providing the read signal corresponding to a first portion of the track to an automatic gain control (AGC) component 302. (Such as at step 400). An output from AGC component 302 is stored, and that output value is indicative of a level of the read signal corresponding to the first portion (e.g., sector) of the track (such as at step 404). The read signal corresponding to a second portion (e.g., sector) of the track is also provided to the AGC component 302 (such as at step 406). A second AGC output value from the AGC component 302, that is indicative of a level of the read signal corresponding to the second portion of the track, is combined with the first AGC output value to obtain a combined AGC output value (such as at step 410). A drive performance operation is performed utilizing the combined AGC output value (such as at step 416).

The step of storing the first AGC output value can include receiving a read gate signal for the first portion of the track; and storing the first AGC output value in response to receiving the read gate signal (such as at steps 400 and 402). The step of combining the first and second AGC output values can include receiving a read gate signal for the second portion of the track, summing the first and second AGC output values in response to receiving the read gate signal to obtain a summed value, and storing the summed value (such as at step 410).

The step of combining can further include averaging the summed value over a number of read gate signals received for the track (such as at step 414).

The steps of receiving a read gate signal associated with a given portion of the track and summing the AGC output value associated with the given portion of the track with the summed value in response to receiving a read gate signal, and storing a new summed value based on that combination, can be repeated for a plurality of additional portions of the track (such as at steps 406-412). The new summed value can be averaged over a total number of read gate signals received for the track to obtain the combined AGC output value (such as at step 414).

In addition, the drive performance operations can include drive testing and drive tuning operations (such as at step 416).

The present invention can also be implemented as a method of performing a drive performance operation on a disc drive 100 having a disc 106 with a data track divided into sectors wherein the method includes writing data in the sectors on the track and reading the data from the sectors by generating a read signal (such as at step 400). The method can further include generating an automatic gain control (AGC) value indicative of a signal amplitude of the read signal (such as at step 404) and calculating an average AGC value over a plurality of the sectors (such as at step 414). The method can further include performing the drive performance operation based on the average AGC values (such as step 416).

The method can further include determining whether each stored AGC value deviates from one or more other AGC values by a preselected amount, and if so, identifying a sector associated with the AGC value that deviates by the preselected amount as a deviant sector and summing only the stored AGC values associated with the sectors that are not deviant sectors (such as by utilizing deviation generator 316, comparator 318, threshold deviation signal 320 and faulty sector indicator 322).

In addition, the invention can include a disc drive 100 comprising a disc 106 having a track and means for determining an average signal amplitude read from the track (such as system 300). The means for determining can further include means for averaging an automatic gain control value over a number of sectors on the track (such as blocks 306-314). The means for determining can also include means for identifying aberrant portions of the track and excluding the aberrant portions from averaging (such as blocks 316 and 318).

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the averaging system while maintaining substantially the same functionality without departing from the scope and spirit of the present invention. In addition, although the preferred embodiment described herein is directed to a AGC system for a disc drive, it will be appreciated by those skilled in the art that the teachings of the present invention can be applied to other channel blocks, without departing from the scope and spirit of the present invention.

What is claimed is:

1. A method of determining a signal level of a read signal in a disc drive generated by a transducer from data written on a track of a disc in the disc drive, the track having at least a first portion and a second portion, the method comprising steps of:
(a) obtaining a combined read signal level value indicative of a value of the read signal generated from a plurality of different portions of the track; and
(b) performing a drive performance operation utilizing the combined read signal level value.

2. The method of claim 1 wherein the obtaining step (a) comprises:
(a1) providing the read signal corresponding to the first portion of the track to an automatic gain control (AGC) component;
(a2) storing a first AGC output value from the AGC component that is indicative of a level of the read signal.
(a3) providing the read signal corresponding to the second portion of the track to the AGC component; and
(a4) combining a second AGC output value from the AGC component that is indicative of a level of the read signal corresponding to the second portion of the track with the first AGC output value to obtain a combined AGC output value; and

3. The method of claim 2 wherein the storing step (a2) comprises:
(a2.1) receiving a read gate signal for the first portion of the track; and
(a2.2) storing the first AGC output value in response to receiving the read gate signal.

4. The method of claim 3 wherein the combining step (a4) comprises:
(a4.1) receiving a read gate signal for the second portion of the track;
(a4.2) summing the first and second AGC output values in response to receiving (a4.1) to obtain a summed value; and
(a4.3) storing the summed value.

5. The method of claim 4 wherein the combining step (a4) further comprises:
(a4.4) averaging the summed value over a number of read gate signals received for the track.

6. The method of claim 4 wherein the track includes a plurality of additional portions and further comprising:
prior to performing drive performance operation (b), for each of the additional portions;
(c) receiving a read gate signal;
(d) summing the AGC output value associated with the given portion with the summed value in response to receiving (c) to obtain a new summed value; and
(e) storing the new summed value.

7. The method of claim 6 and further comprising:
(f) averaging the new summed value over a total number of read gate signals received for the track to obtain the combined AGC output value.

8. The method of claim 1 wherein performing a drive performance operation (b) comprises:
(b1) performing a drive testing operation.

9. The method of claim 1 wherein performing a drive performance operation (b) comprises:
(b1) performing a drive turning operation.

10. The method of claim 6 and further comprising:
(f) prior to the summing step (d) determining whether the AGC value associated with the given portion deviates from one or more AGC values associated with other portions by a preselected threshold amount; and
(g) if so, identifying the given portion as an aberrant portion.

11. The method of claim 10 and further comprising:
(h) proceeding without summing the AGC value associated with the aberrant portion with the summed value.

12. The method of claim 11 and further comprising:
(i) averaging the new summed value over a total number of read gate signals for the track, less those associated with aberrant portions, to obtain the combined AGC output value.

13. A method of performing a drive performance operation on a disc drive having a disc with a data track divided into sectors, comprising:
(a) reading data in the sectors on the track;
(b) generating an automatic gain control (AGC) value indicative of a signal amplitude of the read signal;
(c) calculating a representative AGC value over a plurality of the sectors; and
(d) performing the drive performance operation based on the average AGC value.

14. The method of claim 13 wherein generating (b) comprises:
(b1) receiving a read gate signal corresponding to each of the sectors.

15. The method of claim 14 wherein generating (b) comprises:
(b2) in response to the read gate signals, storing the AGC value to obtain stored AGC values.

16. The method of claim 15 wherein calculating (c) comprises:
(c1) summing the stored AGC values to obtain a summed AGC value; and
(c2) averaging the summed AGC value over a number of the sectors.

17. The method of claim 16 wherein summing (c1) comprises:
(c1.1) determining whether each stored AGC value deviates from one or more other AGC values by a preselected amount;
(c1.2) if so, identifying a sector associated with the AGC value that deviates by the preselected amount as a deviant sector; and
(c1.3) summing only the stored AGC values associated with sectors that are not deviant sectors.

18. The method of claim 13 wherein the drive performance operation comprises a drive tuning operation.

19. The method of claim 13 wherein the drive performance operation comprises a drive testing operation.

20. A disc drive, comprising:
a disc having a track; and
means for determining an average signal amplitude read from the track.

21. The disc drive of claim 20 wherein the means for determining comprises:
means for averaging an automatic gain control value over a number of sectors on the track.

22. The disc drive of claim 20 wherein the means for determining comprises:
means for identifying aberrant portions of the track and excluding the aberrant portions from averaging.
